(19) United States
(12) Patent Application Publication
(10) Pub. No.: US 2014/0351417 A1
(43) Pub. Date: Nov. 27, 2014

(54) SESSION TIMEOUT METHOD FOR DHTMLX INTERFACE CONTROL LIBRARY

(71) Applicant: Tsz Fung Chan, Hong Kong (HK)

(72) Inventor: Tsz Fung Chan, Hong Kong (HK)

(21) Appl. No.: 14/228,449

(22) Filed: Mar. 28, 2014

Related U.S. Application Data
(60) Provisional application No. 61/825,536, filed on May 21, 2013.

(51) Int. Cl. H04L 12/26

(52) U.S. Cl. CPC H04L 43/10
USPC 709/224

(57) ABSTRACT

A session timeout method for DHTMLX interface control libraries is provided. Each DHTMLX interface control library includes a plurality of DHTMLX components. The method includes: sending requests to a server; receiving data and page content from the server with a client; setting up a session timer on the client counting down time remained for a session established between the server and the client; creating a DHTMLX component; monitoring and resetting the session timer upon the DHTMLX component raising a first predetermined event or calling a first action; prompting messages and redirecting a user to a login page upon a second predetermined event or calling a second action; and catching a DHTMLX component error.

### CROSS-REFERENCE TO RELATED APPLICATIONS

This application claims the benefit of U.S. Provisional Patent Application No. 61/825,536 filed on May 21, 2013; the contents of which is hereby incorporated by reference.

### FIELD OF THE PATENT APPLICATION

The present patent application generally relates to information technologies and more specifically to a session timeout method for dhtmlxSuite, dhtmlxScheduler and other dhtmlx interface control libraries.

### BACKGROUND

The dhtmlxSuite and dhtmlxScheduler are interface control libraries developed by DHTMLX Ltd. (http://www.dhtmlx.com). DHTMLX is a trademark of DHTMLX Ltd. DHTMLX Ltd. also produces other software interface control libraries. The components in the libraries can be used to construct interfaces for web applications, mobile applications, tablet applications and other kinds of software. In those interfaces, a user can retrieve, view, insert, update and delete the data in the components. The components in the libraries send the modified data in requests to and receive responses from the servers.

After a user logs in an application, a session will be established between the client machine and the server. A session is a connection between computers established for a certain period of time. The server stores temporary data into the session. A user triggers signals to the server in order to keep the connection alive. If a user is inactive for a period of time, the session expires on the server and the server logs out the user. The server also clears the temporary data stored in the session and releases the system resources used for holding the session. The user needs to log in again in order to continue their actions in the application.

However, components in dhtmlxSuite, dhtmlxScheduler and other dhtmlx libraries are loaded in an Internet browser, an operating system, a software environment or a software runtime on the client machine and cannot detect the session timeout on the server. A user may spend much time on modifying the data inside the dhtmlx components, but realize that the session has already expired only after submitting a request to the server. If the session has already expired on the server, the data modification request from the client machine is ignored by the server and all the modified data is discarded. The server asks the user to log in the system again. The user has to repeat modifying the data and then send the data modification request to the server again.

### SUMMARY

The present patent application is directed to a session timeout method for DHTMLX interface control libraries. In one aspect, each DHTMLX interface control library includes a plurality of DHTMLX components and the method includes: sending requests to a server; receiving data and page content from the server with a client; setting up a session timer on the client counting down time remained for a session established between the server and the client; creating a DHTMLX component; monitoring and resetting the session timer upon the DHTMLX component raising a first predetermined event or calling a first action; prompting messages and redirecting a user to a login page upon a second predetermined event or calling a second action; and catching a DHTMLX component error.

The DHTMLX component may be a grid, the grid being dhtmlxGrid or dhtmlxTreeGrid. The first predetermined event may be a grid event onXLE when data is loaded from a message to the client. The first predetermined event may be a grid event onEditCell when the user opens cells in the grid to edit data. The method may further include checking whether the session is time out; if the session is time out, prompting session timeout message and redirecting the user to a login page after the user accepts the message; and if the session is not time out, resetting the session timer upon the event.

The DHTMLX component may be a data processor, the data processor being dhtmlx DataProcessor. The first predetermined event may be a DataProcessor event onFullSync after all data is saved. The second predetermined event may be a DataProcessor event onBeforeDataSending and the method may further include checking if the session is time out; if the session is time out, prompting a session timeout message and redirecting the user to a login page after the user accepts the message; and if the session is not time out, waiting for the server response of the result of modifying the data.

The first action being called may be a DataProcessor action if a message received from the server is a validation error message. The action may prompt a validation error message. After the user accepts the validation error message, if the session is time out, a session timeout message may be prompted and a user may be redirected to a login page; if the session is not time out, the session timer may be reset.

The DHTMLX component may be an error handler, the error handler being dhtmlxError. The second predetermined event may be a LoadXML error event when a DHTMLX component fails to load the data, the data contains error or there is no message received from the server. The method may further include logging out the user, prompting an error message, and redirecting the user to a login page after the user accepts the error message.

The method may further include generating multiple formatted strings with data groups at the server, embedding all the formatted strings into a web page, and sending the web page to the client at one time for dhtmlx components to load the data. The first predetermined event may be a grid event onXLE when data is loaded from a message to the client. The DHTMLX component may include a systematic arrangement to store data group names, a systematic arrangement to store dhtmlx windows, a systematic arrangement to store dhtmlx grids, and a systematic arrangement to store dhtmlx data processors.

The method may further include starting a thread and carrying out a series of actions: putting the data group names into a systematic arrangement; creating a dhtmlx window and a dhtmlx menu; attaching the menu to a window; putting the window into a systematic arrangement; creating a dhtmlx grid; attaching the grid to a window; loading formatted strings of a data group into a grid; raising a grid event of onXLE to reset the session timer upon the event; putting the grid into a systematic arrangement; creating a dhtmlx data processor; initializing a grid with a data processor; and putting the data processor into a systematic arrangement.

The DHTMLX component may be a scheduler, the scheduler being dhtmlxScheduler. The first predetermined event may be a scheduler event onXLE when data is loaded from a message to the client, or the first predetermined event may be a scheduler event onEventChanged, onLightbox, onEventCut, onEventCopied or onEventPasted when the user edits, opens, cuts, copies or pastes the scheduler tasks respectively. The method may further include checking whether the session is time out; and if the session is time out, prompting a session timeout message and redirecting the user to a login page after the user accepts the message; if the session is not time out, resetting the session timer upon the event.

In another aspect, the present patent application provides a computer network that includes: a web server; a database server connected with the web server; and a client computer being connected to the web server through the Internet and a network security device. The client computer is configured to send requests to the web server, to receive data and page content from the web server, to set up a session timer counting down time remained for a session established between the web server and the client computer, to create a DHTMLX component, to monitor and reset the session timer upon the DHTMLX component raising a first predetermined event or calling a first action, to prompt messages and redirect a user to a login page upon a second predetermined event or action, and to catch a DHTMLX component error. The DHTMLX component is a grid, a data processor, a scheduler or an error handler.

The DHTMLX component may be a grid, the grid may be dhtmlxGrid or dhtmlxTreeGrid, and the first predetermined event may be a grid event onXLE when data is loaded from a message to the client computer, or a grid event onEditCell when a user opens cells in the grid to edit data.

The DHTMLX component may be a scheduler, the scheduler may be dhtmlxScheduler, and the first predetermined event may be a grid event onXLE when data is loaded from a message to the client computer, or the first predetermined event may be a scheduler event onEventChanged, onLightbox, onEventCut, onEventCopied or onEventPasted when the user edits, opens, cuts, copies or pastes the scheduler tasks respectively.

The DHTMLX component may be a data processor. The data processor may be dhtmlx DataProcessor. The first predetermined event may be a DataProcessor event onFullSync. The second predetermined event may be a DataProcessor event onBeforeDataSending, and the first action may be a DataProcessor action. The DHTMLX component may be an error handler, the error handler being dhtmlxError, and the second predetermined event may be a LoadXML error event.

In yet another aspect, the present patent application provides a system for monitoring a session timeout for interface control libraries. Each interface control library includes a plurality of interface control components. The system includes: means for sending requests to a server; means for receiving data and page content from the server with a client; means for setting up a session timer on the client counting down time remained for a session established between the server and the client; means for creating an interface control component; means for monitoring and resetting the session timer upon the interface control component raising a first predetermined event or calling a first action; means for prompting messages and redirecting a user to a login page upon a second predetermined event or action; and means for catching an interface control component error. The interface control component is configured to trigger the predetermined event when the interface control component requests, receives, loads, presents, searches, filters, hides, shows, sorts, adds, updates, deletes, opens, edits, cuts, copies, pastes or closes data records.

### BRIEF DESCRIPTIONS OF THE DRAWINGS

FIG. 1 illustrates the architecture of a system that implements the session timeout method for a DHTMLX interface control library in accordance with an embodiment of the present patent application.

FIG. 2 is a flow chart illustrating a session timeout method for a web page containing a single dhtmlxGrid or dhtmlxTreeGrid (the grid) according to another embodiment of the present patent application.

FIG. 2B is a flow chart illustrating BLOCK 2B in FIG. 2.

FIG. 3 is a flow chart illustrating a session timeout method working with multiple dhtmlxGrid or dhtmlxTreeGrid (the grids) on the same web page according to another embodiment of the present patent application.

FIG. 3B is a flow chart illustrating BLOCK 3B in FIG. 3.

FIG. 3C is a flow chart illustrating BLOCK 3C in FIG. 3.

FIG. 3D is a flow chart illustrating BLOCK 3D in FIG. 3.

FIG. 4 is a flow chart illustrating a session timeout method for dhtmlxScheduler (the scheduler) according to another embodiment of the present patent application.

FIG. 4B is a flow chart illustrating BLOCK 4B in FIG. 4.

FIG. 5 is a graph illustrating an example of dhtmlxGrid.

FIG. 6 is a graph illustrating an example of dhtmlxTreeGrid.

FIG. 7 is a graph illustrating an example of dhtmlxScheduler.

FIG. 8 is a graph illustrating an example of a task popup window in dhtmlxScheduler.

### DETAILED DESCRIPTION

Reference will now be made in detail to a preferred embodiment of the session timeout method for a DHTMLX interface control library disclosed in the present patent application, examples of which are also provided in the following description. Exemplary embodiments of the method disclosed in the present patent application are described in detail, although it will be apparent to those skilled in the relevant art that some features that are not particularly important to an understanding of the method may not be shown for the sake of clarity.

Furthermore, it should be understood that the method disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

Since the events and functions of the dhtmlx components may have been duplicated but with different names, and the names may also vary in future versions of dhtmlx libraries, all event names and function names used in this patent application may represent all the other equivalent events and functions that produce the same or similar effects.

Moreover, individual controls and control libraries other than the products of DHTMLX Ltd. are also available in the market. No matter whether the individual controls and control libraries produced by other parties are used for web applications, mobile applications, tablet applications or other kinds of software, the methods provided by the embodiments of this patent application are also applicable to these individual controls and control libraries, as these individual controls and control libraries would also produce the same or similar problems as aforementioned. All event names and function names used in this patent application may also represent all the other equivalent events and functions that produce the same or similar effects under the individual controls and control libraries produced by other parties.

### System Architecture

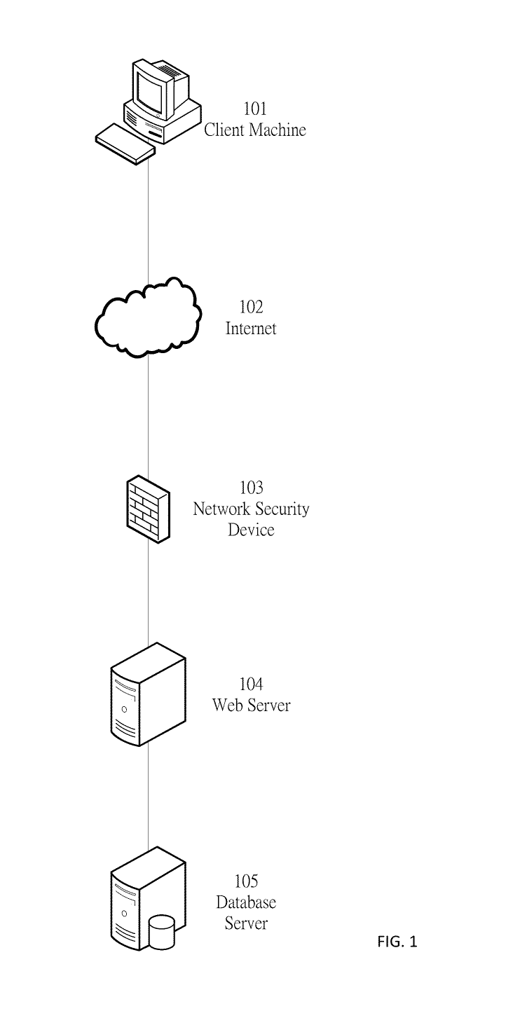

FIG. 1 illustrates the architecture of a system that implements the session timeout method for a DHTMLX interface control library in accordance with an embodiment of the present patent application. Referring to FIG. 1, a system user uses a computer 101 to access the system through the Internet 102. The computer can be a desktop computer, laptop computer, tablet computer, mobile phone or any other type of hardware devices. The computer 101 can also be a server machine if the user uses the server machine as a client machine. The system user and the computer 101 are on the client side. In order to restrict unauthorized access to the system, the connection passes through a network security device such as a firewall and intrusion detection system 103. The web application is hosted on a web server 104. The web server 104 communicates with a database server 105. The database server 105 stores the database of the system.

Session Timeout Mechanism for dhtmlxGrid

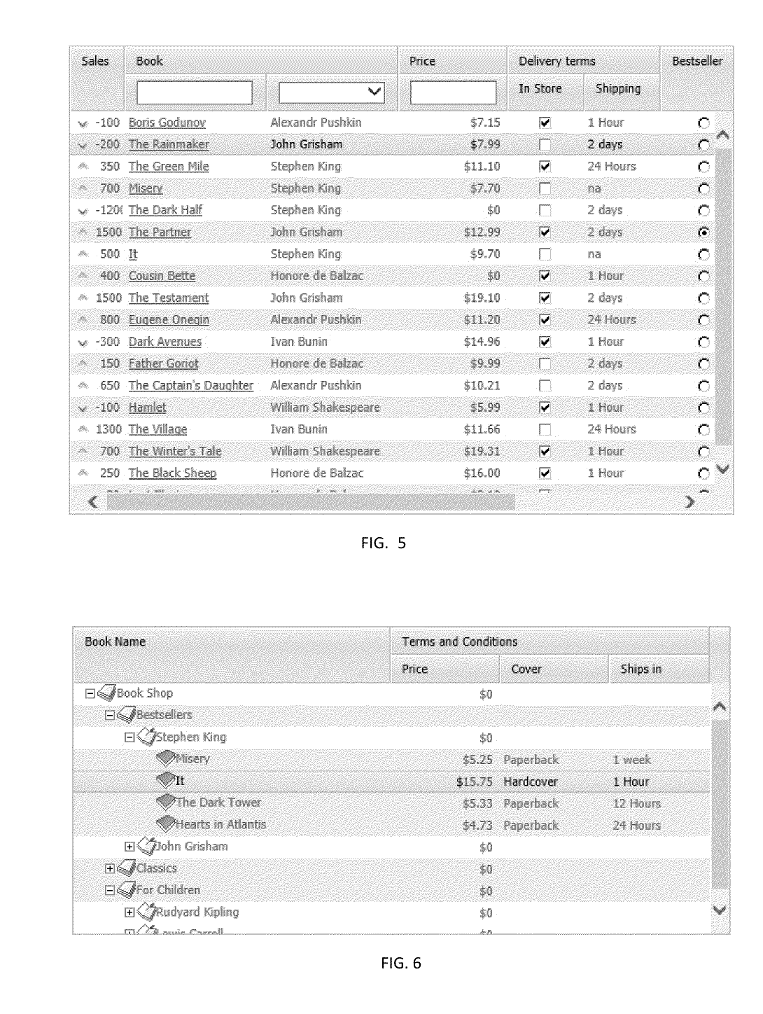

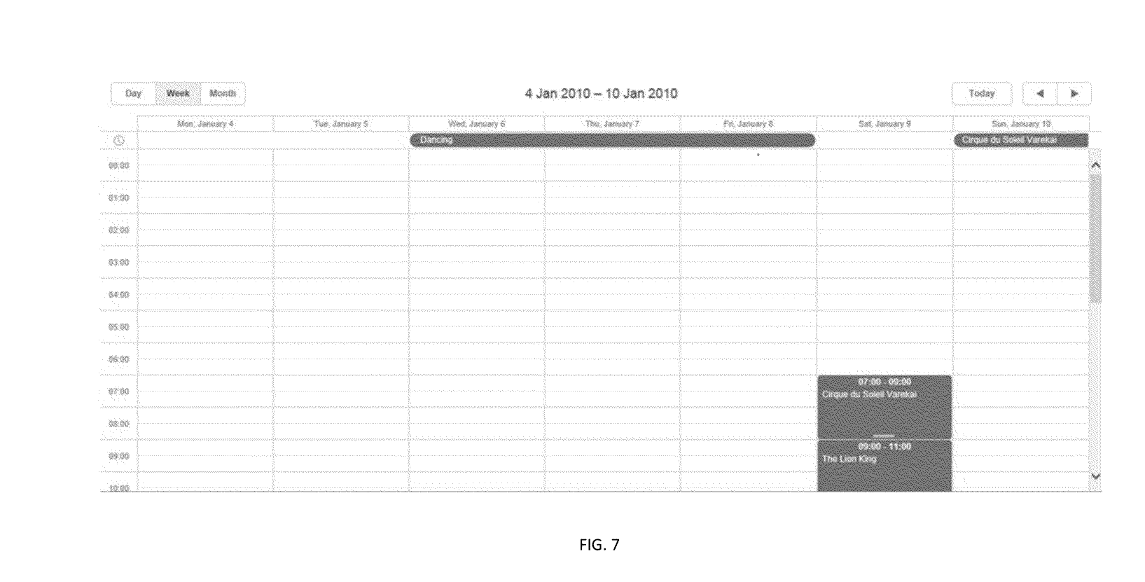

In dhtmlx libraries, dhtmlxGrid (as illustrated in FIG. 5) and dhtmlxTreeGrid (as illustrated in FIG. 6) are interface components that show data in rows and columns A dhtmlxTreeGrid also enables the users to click to expand or collapse the nodes in a grid column in order to show or hide the rows that belong to the same branch or the entire tree. A dhtmlxScheduler (as illustrated in FIG. 7) shows tasks allocation among a timetable or a calendar. A dhtmlx DataProcessor is the component to communicate the requests and responses between the dhtmlx components and the server in Extensible Markup Language (XML) or other formats. XML is a format to encode documents. It is defined in the XML 1.0 Specification produced by the World Wide Web Consortium (W3C). W3C is the main international standards organization for the World Wide Web.

In this patent application, the messages in the flows are illustrated in XML and JSON formats. However, the dhtmlx components can also communicate with the server and load the data in the formats of XML, JavaScript Object Notation (JSON), Hypertext Markup Language (HTML) table, comma-separated values (CSV), JavaScript array and the other custom loading types. The XML and JSON formats described in this patent application may be substituted by the other data formats if applicable.

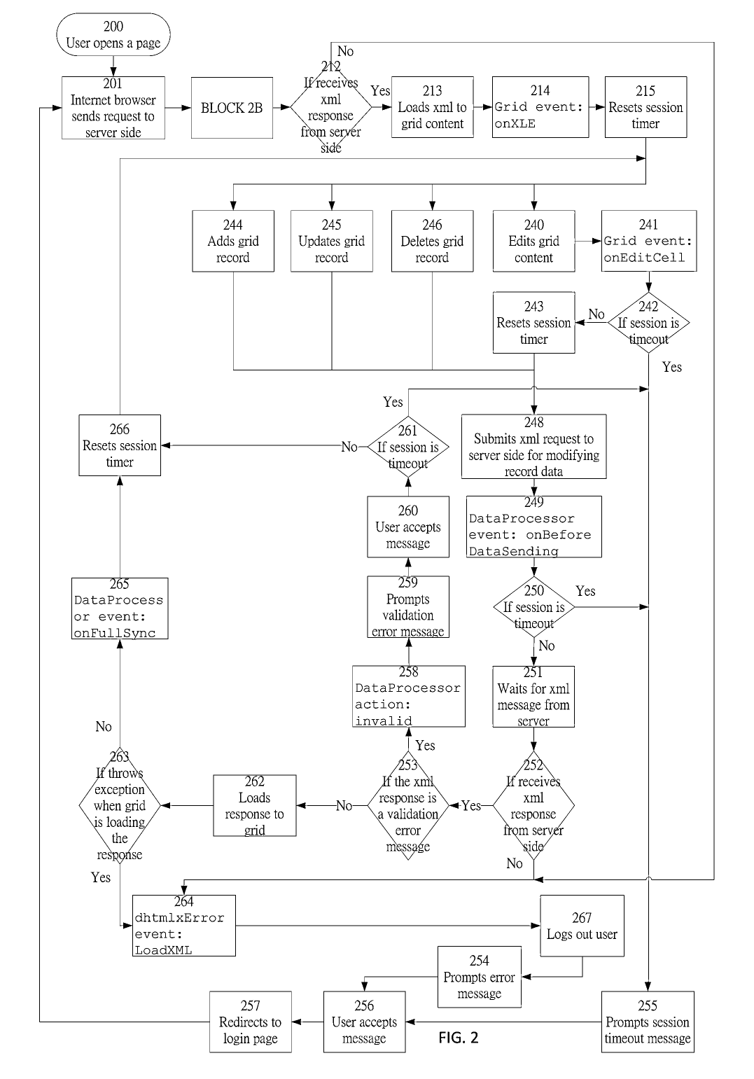

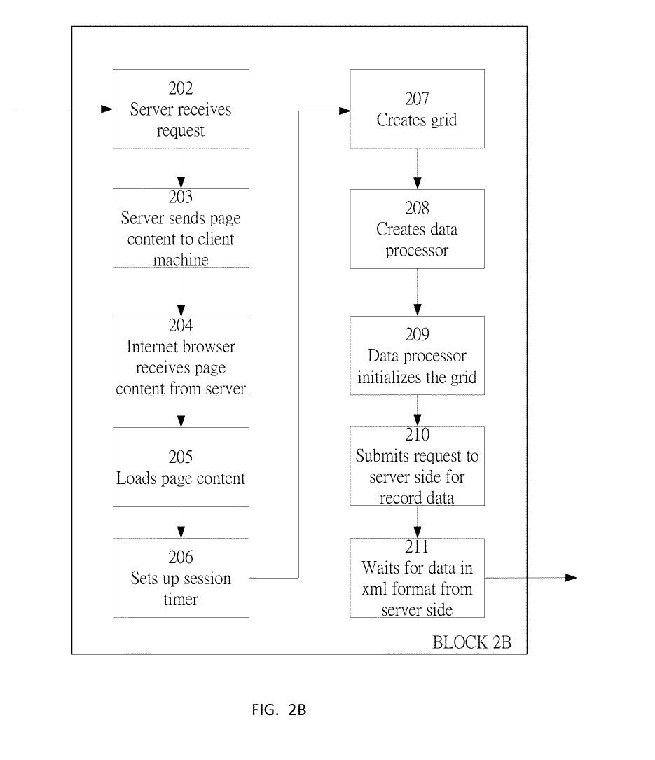

FIG. 2 is a flow chart illustrating a session timeout method for a web page containing a single dhtmlxGrid or dhtmlxTreeGrid according to another embodiment of the present patent application. Referring to FIG. 2, the method starts at step 200 when a user opens a page. The Internet browser on the client machine sends a request to the server in step 201. The server receives the request in step 202 and sends page content to the client machine in step 203. In the page content, the server also embeds the session time duration.

After the Internet browser receives the response in step 204, it loads the page content in step 205 and sets up a session timer for the page in step 206 according to the session time duration in the page content. The Internet browser creates a dhtmlxGrid or dhtmlxTreeGrid (the grid) in step 207 and a dhtmlx DataProcessor (the data processor) in step 208. The data processor initializes the grid in step 209. The grid sends a request to the server to ask for data to fill the grid in step 210. The request is in XML format. The Internet browser waits for the grid content in XML format from the server side in step 211. The server loads the record data from database, generates the response in XML format, and sends it to the client side.

If the grid cannot receive the XML message in step 212, the dhtmlxError will catch the LoadXML error event in step 264. The dhtmlxError is a custom error handler in dhtmlx libraries. The page logs out the user in step 267 to expire the session, then prompts an error message in step 254, and then redirects to a login page in step 257 after the user accepts the message in step 256. If the Internet browser receives the XML message from the server side in step 212, the page loads XML message into the grid in step 213. The grid raises an event of onXLE in step 214 after loading the data from the XML message. In the event of onXLE, it resets the session timer in step 215.

After the grid loads the XML message, it shows the data received from the server. User can edit the grid content in step 240. When a user opens the cells in the grid to edit the data, the grid raises an event of onEditCell in step 241. The event checks if the session times out in step 242. If the session is time out, it prompts session timeout message in step 255 then redirects to a login page in step 257 after user accepts the message in step 256. If the session is not time out in step 242, the page resets session timer in step 243 because the user is still active. User can add, update and delete grid content in steps 244, 245 and 246 respectively through various functions of the dhtmlx components. The editing, adding, updating, deleting actions submit a request for modifying data to the server in XML format in step 248.

Then data processor raises an event of onBeforeDataSending in step 249. The event checks if the session is time out in step 250. If the session is time out, it prompts session timeout message in step 255 then redirects to a login page in step 257 after the user accepts the message in step 256. If the session is not time out in step 250, the page waits for the server response of the result of modifying the data in XML format in step 251.

If the page cannot receive XML message from the server side in step 252, the dhtmlxError will catch the LoadXML error event in step 264. The event logs out the user in step 267 to expire the session, then prompts an error message in step 254, and then redirects to a login page in step 257 after the user accepts the message in step 256.

If the page receives XML message from the server side in step 252, the data processor will check if the XML is a validation error message in step 253 by checking if the action type field in the XML message contains ‘invalid’ as its value. The server sets the value of the action type field to be ‘invalid’ when it finds there is any validation error in the validation check. A validation check is the process to verify the data values and types. The value of the action type field can be any other word. The server has to match the word that has been specified in the data processor action. If the message is a validation error message in step 253, the data processor recognizes the word ‘invalid’ and triggers the action in step 258. The action prompts the validation error message in step 259. The user accepts the message in step 260 and the page checks if the session is time out in step 261.

If the session is time out in step 261, it prompts session timeout message in step 255 then redirects to a login page in step 257 after user accepts the message in step 256. If the session is not time out in step 261, the page resets the session timer in step 266 and user can continue to edit the grid content in step 240, 244, 245 or 246.

If the XML response is not a validation error message in step 253, the grid loads the server response in step 262. If the grid throws exception when it loads the response in step 263, the dhtmlxError will catch the LoadXML error event in step 264. The event logs out the user in step 267 to expire the session, then prompts an error message in step 254, and then redirects to a login page in step 257 after the user accepts the message in step 256.

If the grid loads the response successfully in step 262, it will not throw exception in step 263. Then data processor raises event of onFullSync in step 265. The event resets the session timer in step 266. Then user can continue to modify the grid content in step 240, 244, 245 or 246.

### Session Timeout Mechanism for Multiple Grids

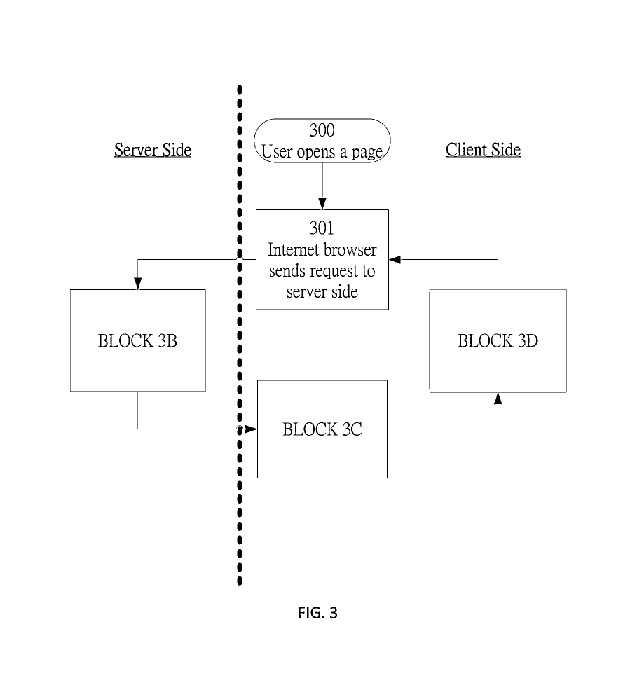

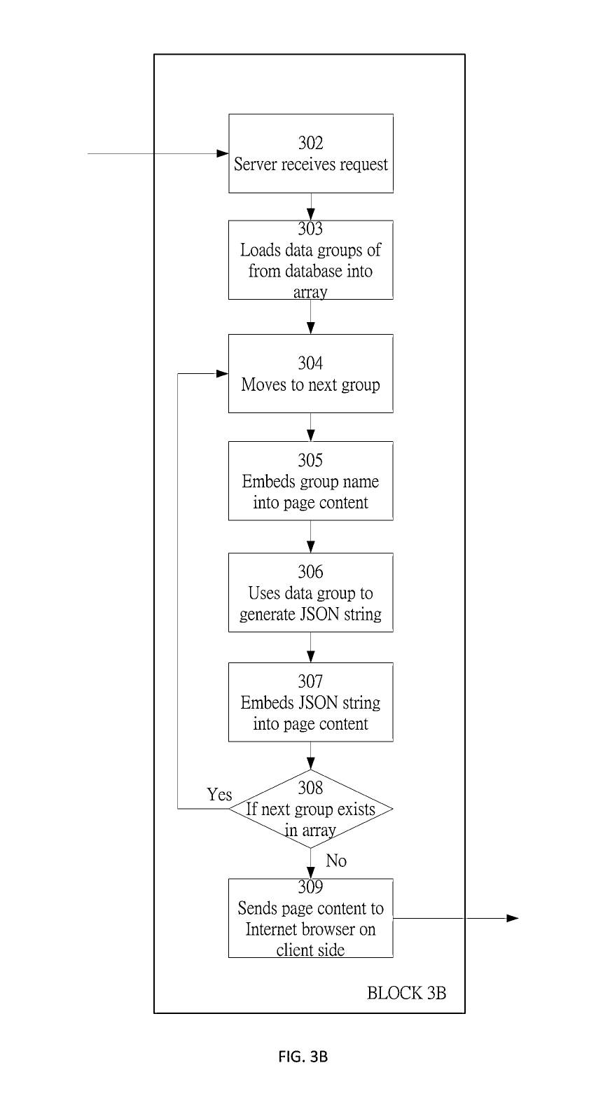

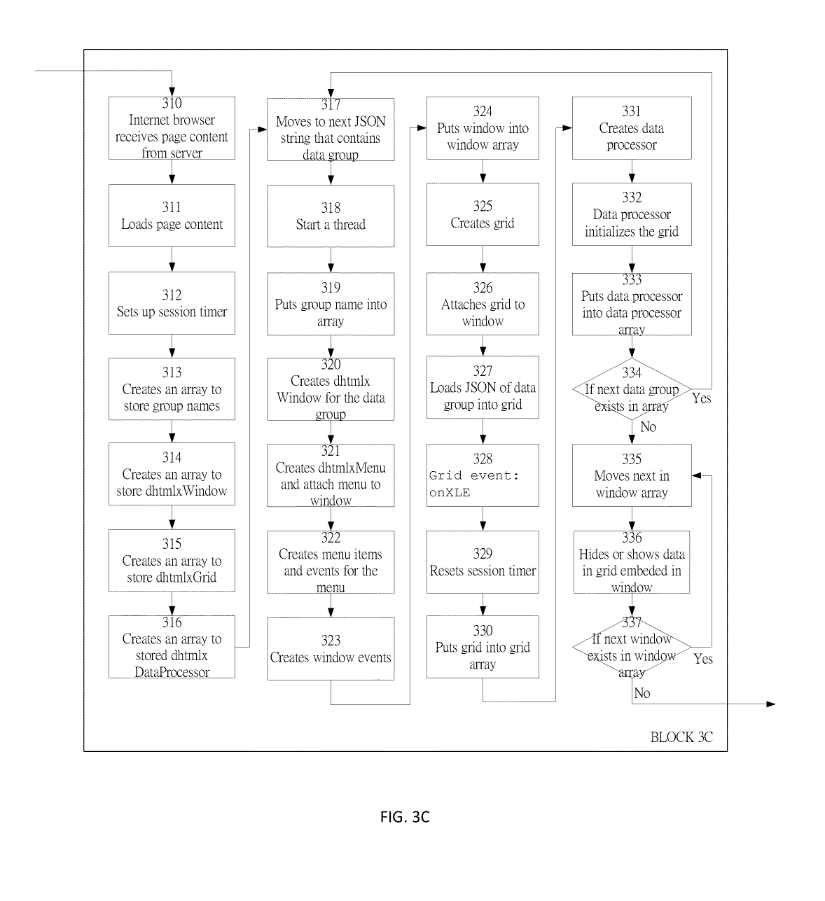

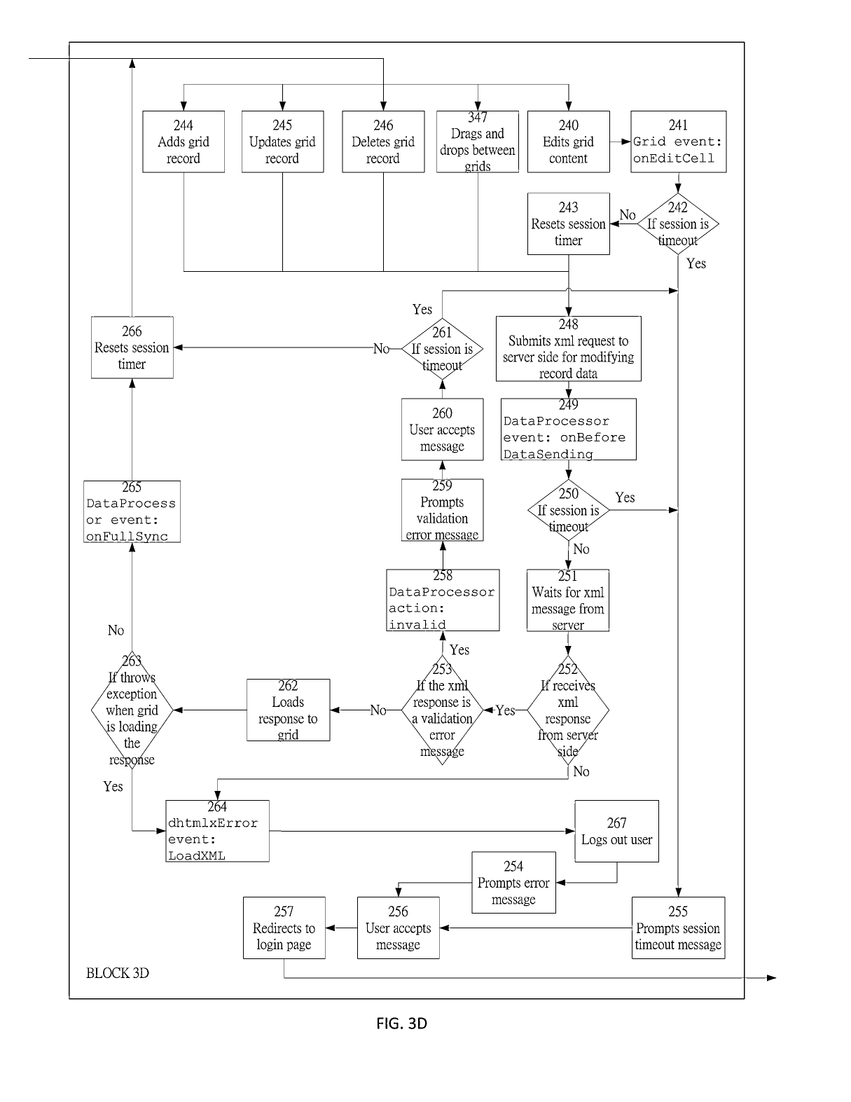

On top of the session timeout mechanism for dhtmlxGrid in FIG. 2, a method according to another embodiment of the present patent application has a more advanced session timeout mechanism in FIG. 3.

Sometimes it is more convenient to classify data in groups. This method presents data groups in multiple dhtmlxGrid or dhtmlx TreeGrid (the grids) on the same web page. For each group of data, the page creates a dhtmlx Window (the window) to contain the grid and a dhtmlx Menu (the menu) for the widow. There are buttons on the menu for adding, deleting and modifying records in the grid. The page also creates a dhtmlx DataProcessor (the data processor) for each grid for communication with server. A user can update the data and modify the data grouping by dragging and dropping the data among the grids.

A disadvantage of loading multiple grids on a single web page is that the Internet browser needs a long time to render and load the grids one after another, because the processes to create multiple grids are queuing in the same execution path. The Internet browser can create a new grid only after the former grid finished its loading. Users have to wait for a long time before all the grids are completely loaded. The Internet browser may also halt under this condition because it is too busy.

Another problem is that the grids still have no mechanism to monitor the session time, just like the case in FIG. 2. Moreover, there is no way to locate, call, control, manage or take other actions on the multiple grids on the web page.

The method in this patent application provides solutions to create multiple grids under management, increase the loading speed and monitor the session timeout on a page containing multiple grids.

Although the dhtmlx components can be initialized without storing them into any arrangement, this method provides systemic arrangements to store the data group names, grids, data processors, and windows. The system can locate the objects or values stored in the arrangements in order to retrieve them and impose actions on them. The illustration uses separated arrays to be the arrangements. However, the arrays represent all the other equivalent systemic arrangements or object collection structures that perform the same function. An array is a systematic arrangement of a collection of values or objects.

For each data group, the web page creates a name, a grid, a data processor, a window and a menu, and then puts them into their respective arrays. By searching the name in the data group name array, the system can locate the index of the name in the array. Since the sequences of the other arrays are the same, the components at the same index number in the other arrays are also representing the same data group. Through this method, the system can keep the objects under control since the system can locate and call them by the indexes in the arrays and then take some actions on the objects.

Previously in FIG. 2, the grid sends a request to the server to ask for the grid content, then receives and loads the server response that contains record data in XML format. When there is more than one grid on a single web page, each grid submits its own request to the server to ask for the record data. As result, the server becomes busy because it needs to receive many requests and response to every grid. Thus letting the grids to send multiple requests is not the optimum way to create multiple grids on one web page.

In FIG. 3, the advanced method uses JavaScript Object Notation (JSON) format for loading record data into multiple grids instead of using XML. JSON is a text-based open standard designed for data interchanging. It is created according to the JavaScript. JavaScript is a client side programming language running on the Internet browser to control the web page components.

In order to save system resources, server does not response to multiple requests from multiple grids. Instead, the server uses the data groups to generate multiple strings in JSON format, then embeds all the JSON strings into the web page and sends it to the client machine at a single time.

Since the server embeds the JSON strings into the web page, the grids can load the record data from the web page. There is no need for the grids to send requests to the server to ask for record data. This can shorten the loading time of the web page and keep the server less busy by receiving fewer requests sent separately from multiple grids.

When a user opens the page in step 300 to open a page, the Internet browser sends a request to the server in step 301. The server receives the request in step 302. The server retrieves data from database, classifies the data into groups and puts the data group into an array in step 303.

The server loops though each group in the array in step 304. For each group in the array, it embeds the group name and other group attribute values into the page content in step 305. Then the server uses the data in the group to generate a string in JSON format for the data group in step 306. The server embeds the JSON string into the page content in step 307. If there is more groups in the group array in step 308, server loops back to step 304.

After looping all the data groups, the server sends page content in response to the Internet browser on client side in step 309. After the Internet browser receives the response in step 310, it loads the page content in step 311 and sets up a session timer for the page in step 312. The session timer is the only session timer in the web page. Everything on the page will refer only to this session timer when it checks the session time.

The Internet browser creates an array for storing data group names in step 313, an array for storing windows in step 314, an array for storing the grids in step 315 and an array for storing data processors in step 316. If there are more group attribute values or dhtmlx components, other new separated arrays can be created as the storage for them.

The server will loop though each JSON string of the data groups in the page in step 317. For each group, a separated thread is used in step 318 to wrap the grid loading processes (steps 319 to 333) to increase the web page loading speed. A thread is an execution path that can proceed independently from other execution paths. Multiple threads can proceed simultaneously. In a multi-threading environment, a new grid can be created without waiting the former grid to finish its loading, as the former grid is being created under the process of another thread.

In each thread, the Internet browser puts group name into group name array in step 319, and it creates a window for the data group in step 320. The Internet browser creates a menu and attaches the menu to the window in step 321, then creates menu items, menu buttons and menu events in step 322.

After these, the Internet browser creates window events in step 323 then puts the window to the window array in step 324. The Internet browser creates a grid in step 325 and attaches the grid to the window in step 326. The grid loads JSON message of a data group in step 327. This raises the grid event of onXLE in step 328 and the event resets the session timer in step 329. After the grid loads JSON message, the Internet browser puts the grid into grid array in step 330.

Then the Internet browser creates a data processor in step 331 and the data processor initializes the grid in step 332. The Internet browser puts the data processor into the data processor array in step 333.

If there are more JSON strings of the data groups in the web page in step 334, the Internet browser loops back to step 317.

Since the Internet browser creates a group name, a window, a menu, a grid and a data processor for each data group in order, the length of the group name array, the length of window array, the length of grid array and length of data processor array are the same. The objects of the same index in the arrays represent the same data group. If the system has either an index number of a table name, a window, a grid or a data processor, the system can find the other objects representing the same data group in their respective arrays by using the same index number.

After loading all tables, the Internet browser moves to the front of the window array in step 335. By looping through each of the windows in the window array, in step 336 the Internet browser can do some settings to the window such as positioning, and also hide or show the data in the grid inside the window according to some criteria. If there are more windows in the window array in step 337, the Internet browser loops back to step 335. By putting the window into array, the Internet browser can locate and call a specific window by index or looping through all the windows in the array in order to take actions on the windows or the data inside the grids within the windows. The looping from step 335 to 337 is an example of the method to locate, call, control, manage or take other actions on multiple dhtmlx components on a web page by putting them into and retrieving them from the arrays.

After step 337, this method also makes use of the session time out mechanism in step 240 to 267 mentioned in FIG. 2. Steps 240 to 267 in FIG. 2 and Steps 240 to 267 in FIG. 3 are the same. Steps 240 to 267 in FIG. 3 apply to every individual grid and data processor on the web page. Although the page has more grids than FIG. 2, all the actions in the grid events and data processor events in FIG. 3 refer to the same single session timer on the web page.

Another difference between FIG. 2 and FIG. 3 is that in FIG. 3 a user can drag and drop data between different grids in step 347. The grids represent different data groups as mentioned before. The drag-n-drop action moves the records between data groups. Step 347 in FIG. 3 does not exist in FIG. 2.

Session Timeout Mechanism for dhtmlxScheduler

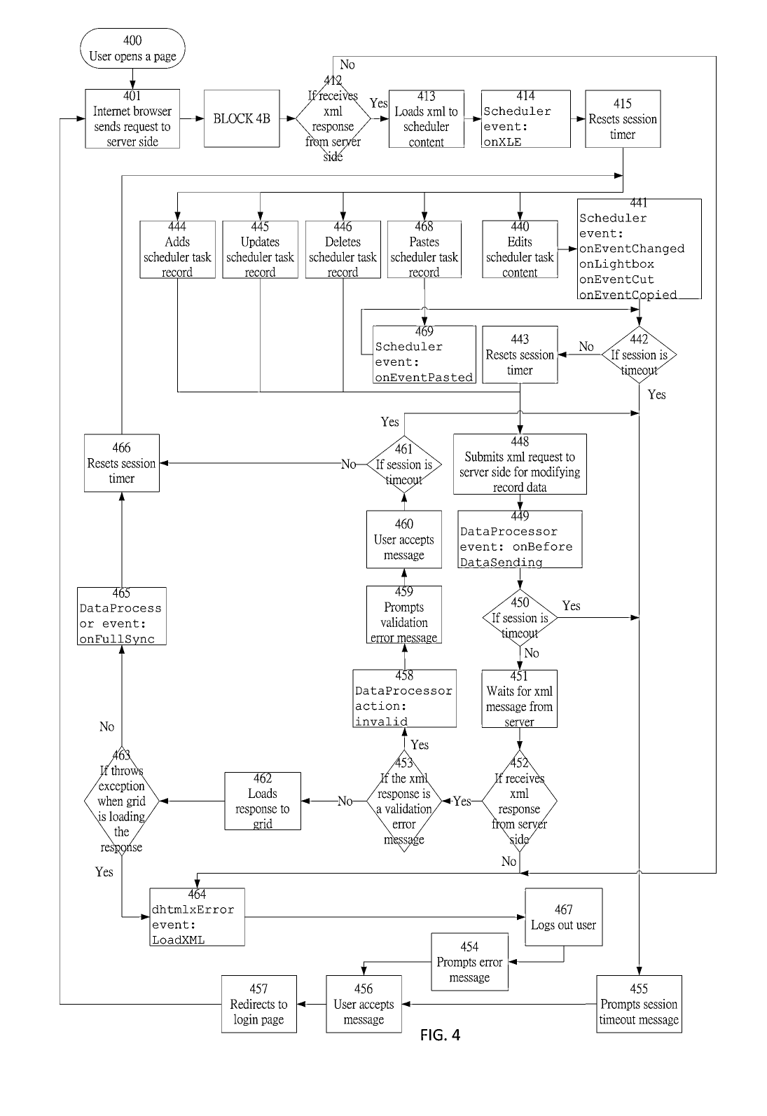

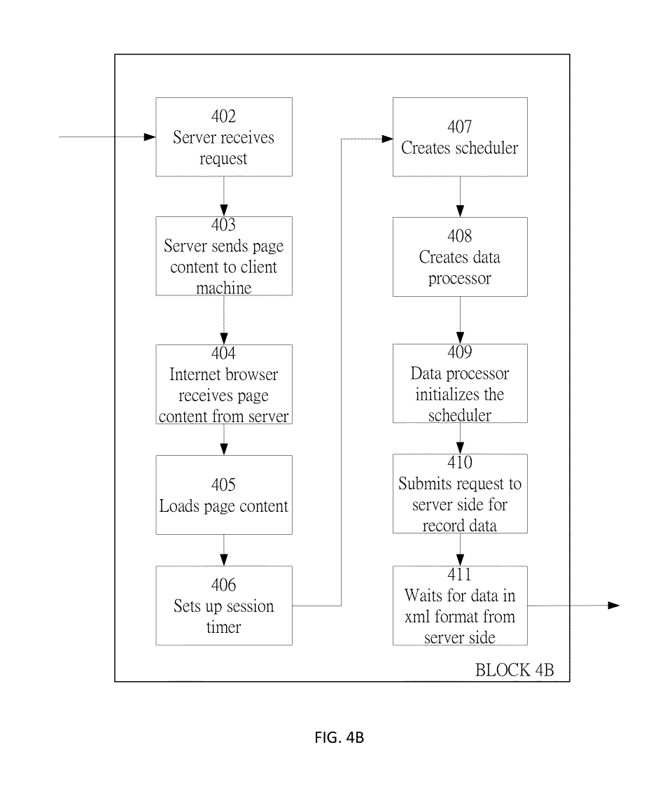

FIG. 4 is a flow chart illustrating a session timeout method for dhtmlxScheduler (the scheduler) according to another embodiment of the present patent application. The scheduler is for organizing the rundown of tasks in a timetable or calendar. There is no session timeout mechanism implemented in the dhtmlx components. The method in this embodiment makes use of the events of dhtmlxScheduler and dhtmlx DataProcessor to count down and monitor the session timeout. The scheduler and data processor generate different events under various conditions. This method starts, resets and monitors the session time in the events on the client side. As result, user can realize the session timeout before modifying the data. The user does not need to spend time on modifying the data before submitting a request that will be ignored and discarded by the server after the session is timeout.

The flow in FIG. 4 is the same as that in FIG. 2 except for several differences. One of the differences is that the grid is substituted by scheduler in the whole flow. The grid in FIG. 2 and the scheduler in FIG. 4 can also be substituted by other components in dhtmlx libraries. The method in this document is also applicable to other dhtmlx products.

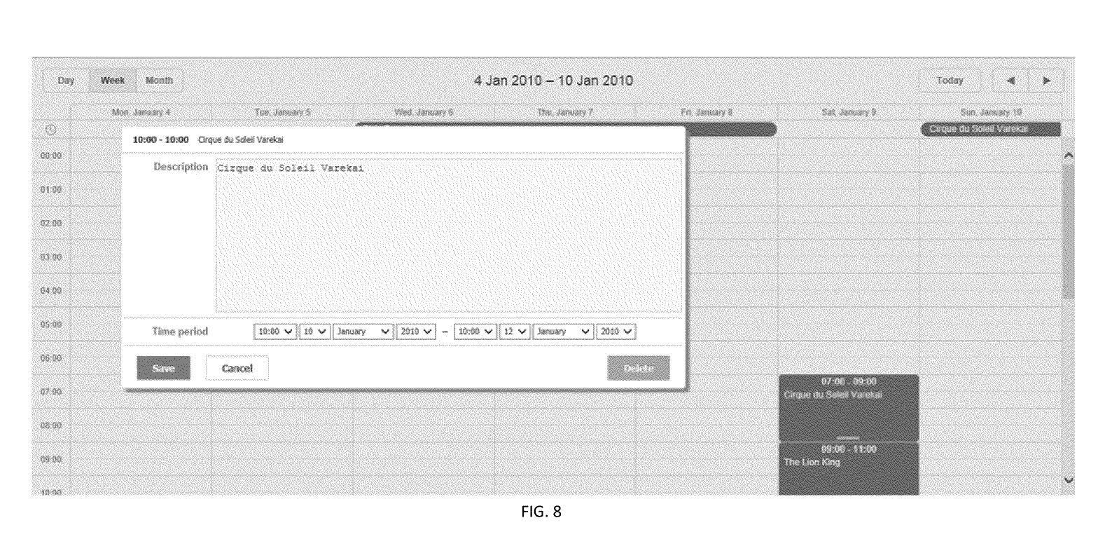

Another difference is in step 441, the grid event onEditCell is substituted by scheduler events onEventChanged, onLightbox, onEventCut or onEventCopied. The scheduler event onEventChanged is triggered when a user drags a task within a scheduler to update the start and end time of the task. The scheduler event onLightbox is triggered when a popup window (as illustrated in FIG. 8) opens in scheduler after user clicks a task in the scheduler. The popup window shows the task details for user to edit. The onEventCut event is triggered when a task is cut in the scheduler during a “cut and paste” action. The onEventCopied event is triggered when a task is copied in the scheduler during a “copy and paste” action. These events can be substituted by other events that open data record for user editing if the method applies to other dhtmlx components. Other dhtmlx components also trigger events when they open data records for user editing.

Yet another difference is in step 468 and step 469. When a task is pasted in the scheduler by a “cut and paste” action or a “copy and paste” action in step 468, the onEventPasted event is triggered in step 469. In this event, the Internet browser can also take actions to check if the session is timeout in step 442. These events can be substituted by other events that close data record after user editing if this method applies to other dhtmlx components. Other dhtmlx components also trigger events when they close data records after user editing.

According to another embodiment, a session timeout method for DHTMLX interface control libraries is provided. Each DHTMLX interface control library includes a plurality of DHTMLX components. The method includes: sending requests to a server; receiving data and page content from the server with a client; setting up a session timer on the client counting down time remained for a session established between the server and the client; creating a DHTMLX component; monitoring and resetting the session timer upon the DHTMLX component raising a first predetermined event or calling a first action; prompting messages and redirecting a user to a login page upon a second predetermined event or calling a second action; and catching a DHTMLX component error.

According to yet another embodiment, a computer network is provided, which includes: a web server; a database server connected with the web server; and a client computer being connected to the web server through the Internet and a network security device. The client computer is configured to send requests to the web server, to receive data and page content from the web server, to set up a session timer counting down time remained for a session established between the web server and the client computer, to create a DHTMLX component, to monitor and reset the session timer upon the DHTMLX component raising a first predetermined event or calling a first action, to prompt messages and redirect a user to a login page upon a second predetermined event or action, and to catch a DHTMLX component error. The DHTMLX component is a grid, a data processor, a scheduler or an error handler.

According to still another embodiment, a system for monitoring a session timeout for interface control libraries is provided. Each interface control library includes a plurality of interface control components. The system includes: means for sending requests to a server; means for receiving data and page content from the server with a client; means for setting up a session timer on the client counting down time remained for a session established between the server and the client; means for creating an interface control component; means for monitoring and resetting the session timer upon the interface control component raising a first predetermined event or calling a first action; means for prompting messages and redirecting a user to a login page upon a second predetermined event or action; and means for catching an interface control component error. The interface control component is configured to trigger the predetermined event when the interface control component requests, receives, loads, presents, searches, filters, hides, shows, sorts, adds, updates, deletes, opens, edits, cuts, copies, pastes or closes data records.

In above embodiments, the session timeout method makes use of the events generated by the dhtmlx components. The method sets up a timer on the web page on the client side to monitor the session time. In the program code, an event is a scope of program code that is triggered by another scope of the program. In the event, actions can be taken to renew or monitor the session timer, prompt messages to the user, log out the user and redirect the user to a login page. The method is applicable to all dhtmlx products if they need to communicate with the server, as the dhtmlx components also generate the events when they communicate with the server.

The session timeout method is designed for the interface component library dhtmlxSuite, dhtmlxScheduler, other dhtmlx products as well as individual controls and control libraries that are produced by other parties for various types of software. The interface components are used to construct software interfaces for a user to communicate with the server. Through the method, the user can realize the session timeout before editing the data and sending a request to the server. The user can avoid spending time on editing the data after the session timeout. The method thus prevents the user from wasting time on modifying the data after the session timeout. The method also makes the server less busy and more secured, since after session timeout it keeps the server from responding to a request that will be ignored and discarded.

While the present patent application has been shown and described with particular references to a number of embodiments thereof, it should be noted that various other changes or modifications may be made without departing from the scope of the present invention.

What is claimed is:

1. A session timeout method for DHTMLX interface control libraries, each DHTMLX interface control library comprising a plurality of DHTMLX components, the method comprising:
sending requests to a server;
receiving data and page content from the server with a client;
setting up a session timer on the client counting down time remained for a session established between the server and the client;
creating a DHTMLX component;
monitoring and resetting the session timer upon the DHTMLX component raising a first predetermined event or calling a first action;
prompting messages and redirecting a user to a login page upon a second predetermined event or calling a second action; and
catching a DHTMLX component error.

2. The method of claim 1, wherein the DHTMLX component is a grid, the grid being dhtmlxGrid or dhtmlxTreeGrid.

3. The method of claim 2, wherein the first predetermined event is a grid event onXLE when data is loaded from a message to the client.

4. The method of claim 2, wherein the first predetermined event is a grid event onEditCell when the user opens cells in the grid to edit data.

5. The method of claim 4 further comprising checking whether the session is time out; if the session is time out, prompting session timeout message and redirecting the user to a login page after the user accepts the message; and if the session is not time out, resetting the session timer upon the event.

6. The method of claim 1, wherein the DHTMLX component is a data processor, the data processor being dhtmlx DataProcessor.

7. The method of claim 6, wherein the first predetermined event is a DataProcessor event onFullSync after all data is saved.

8. The method of claim 6, wherein the second predetermined event is a DataProcessor event onBeforeDataSending, further comprising checking if the session is time out; if the session is time out, prompting a session timeout message and redirecting the user to a login page after the user accepts the message; and if the session is not time out, waiting for the server response of the result of modifying the data.

9. The method of claim 6, wherein the first action being called is a DataProcessor action if a message received from the server is a validation error message, the action prompts a validation error message, and after the user accepts the validation error message, if the session is time out, a session timeout message is prompted and the user is redirected to a login page; if the session is not time out, the session timer is reset.

10. The method of claim 1, wherein the DHTMLX component is an error handler, the error handler being dhtmlxError.

11. The method of claim 10, wherein the second predetermined event is a LoadXML error event when a DHTMLX component fails to load the data, the data contains error or there is no message received from the server, further comprising logging out the user, prompting an error message, and redirecting the user to a login page after the user accepts the error message.

12. The method of claim 1 further comprising generating multiple formatted strings with data groups at the server, embedding all the formatted strings into a web page, and sending the web page to the client at one time for dhtmlx components to load the data; wherein the first predetermined event is a grid event onXLE when data is loaded from a message to the client.

13. The method of claim 12, wherein the DHTMLX component comprises a systematic arrangement to store data group names, a systematic arrangement to store dhtmlx windows, a systematic arrangement to store dhtmlx grids, and a systematic arrangement to store dhtmlx data processors.

14. The method of claim 13 further comprising starting a thread and carrying out a series of actions: putting the data group names into a systematic arrangement; creating a dhtmlx window and a dhtmlx menu; attaching the menu to a window; putting the window into a systematic arrangement; creating a dhtmlx grid; attaching the grid to a window; loading formatted strings of a data group into a grid; raising a grid event of onXLE to reset the session timer upon the event; putting the grid into a systematic arrangement; creating a dhtmlx data processor; initializing a grid with a data processor; and putting the data processor into a systematic arrangement.

15. The method of claim 1, wherein the DHTMLX component is a scheduler, the scheduler being dhtmlxScheduler.

16. The method of claim 15, wherein the first predetermined event is a scheduler event onXLE when data is loaded from a message to the client, or the first predetermined event is a scheduler event onEventChanged, onLightbox, onEventCut, onEventCopied or onEventPasted when the user edits, opens, cuts, copies or pastes the scheduler tasks respectively, further comprising checking whether the session is time out; and if the session is time out, prompting a session timeout message and redirecting the user to a login page after the user accepts the message; if the session is not time out, resetting the session timer upon the event.

17. A computer network comprising:
a web server;
a database server connected with the web server; and
a client computer being connected to the web server through the Internet and a network security device; wherein:
the client computer is configured to send requests to the web server, to receive data and page content from the web server, to set up a session timer counting down time remained for a session established between the web server and the client computer, to create a DHTMLX component, to monitor and reset the session timer upon the DHTMLX component raising a first predetermined event or calling a first action, to prompt messages and redirect a user to a login page upon a second predetermined event or action, and to catch a DHTMLX component error; and
the DHTMLX component is a grid, a data processor, a scheduler or an error handler.

18. The computer network of claim 17, wherein the DHTMLX component is a grid, the grid is dhtmlxGrid or dhtmlxTreeGrid, and the first predetermined event is a grid event onXLE when data is loaded from a message to the client computer, or a grid event onEditCell when a user opens cells in the grid to edit data; or the DHTMLX component is a scheduler, the scheduler is dhtmlxScheduler, and the first predetermined event is a grid event onXLE when data is loaded from a message to the client computer, or the first predetermined event is a scheduler event onEventChanged, onLightbox, onEventCut, onEventCopied or onEventPasted when the user edits, opens, cuts, copies or pastes the scheduler tasks respectively.

19. The computer network of claim 17, wherein the DHTMLX component is a data processor, the data processor is dhtmlx DataProcessor, the first predetermined event is a DataProcessor event onFullSync, the second predetermined event is a DataProcessor event onBeforeDataSending, and the first action is a DataProcessor action; or the DHTMLX component is an error handler, the error handler being dhtmlxError, and the second predetermined event is a LoadXML error event.

20. A system for monitoring a session timeout for interface control libraries, each interface control library comprising a plurality of interface control components, the system comprising:
means for sending requests to a server;
means for receiving data and page content from the server with a client;
means for setting up a session timer on the client counting down time remained for a session established between the server and the client;
means for creating an interface control component;
means for monitoring and resetting the session timer upon the interface control component raising a first predetermined event or calling a first action;
means for prompting messages and redirecting a user to a login page upon a second predetermined event or action; and
means for catching an interface control component error; wherein:
the interface control component is configured to trigger the predetermined event when the interface control component requests, receives, loads, presents, searches, filters, hides, shows, sorts, adds, updates, deletes, opens, edits, cuts, copies, pastes or closes data records.
